(19) United States
(12) Patent Application Publication
(10) Pub. No.: US 2021/0295471 A1
(43) Pub. Date: Sep. 23, 2021

(54) ELECTRONIC DEROTATION OF PICTURE-IN-PICTURE IMAGERY

(71) Applicant: Raytheon Company, Waltham, MA (US)

(72) Inventors: Marcos Bird, McKinney, TX (US); Liam Skoyles, McKinney, TX (US); Christopher J. Beardsley, McKinney, TX (US)

(73) Assignee: Raytheon Company, Waltham, MA (US)

(21) Appl. No.: 16/825,823

(22) Filed: Mar. 20, 2020

(51) Int. Cl. G06T 3/60; G06T 3/40; G06T 3/00

(52) U.S. Cl. CPC G06T 3/606; G06T 3/0093; G06T 3/4007

(57) ABSTRACT

Electronically derotating a picture-in-picture video source can be used to independently derotate a secondary video source separate a primary video source. A method of electronically derotating a picture-in-picture image are described herein, the method comprising processing a first image having a first image primary axis; processing a second image having a second image primary axis; derotating the second image around the second image primary axis to align the second image primary axis substantially parallel with the first image primary axis; and displaying the first image and the second image on a display.

### FIELD OF THE TECHNOLOGY

The subject disclosure relates to derotation of imagery and more particularly to electronic derotation of picture-in-picture imagery.

### BACKGROUND OF TECHNOLOGY

In a system comprising a primary video source and a secondary video source, it is a common occurrence that the primary video source, the secondary video source, or both require image derotation to provide proper image orientation relative to an operator. Derotation is required when a rotated video source is collected—typically by a moving sensor or external device. Derotation avoids having to physically orient oneself to rotated imagery shown on a display.

Previous attempts of derotation image frames have used electro-optical mechanical systems to derotate the sensor itself. These attempts include employing a motor paired with the sensor wherein the motor rotates to keep the sensor vertically aligned. Other conventional derotation techniques have used prisms to derotate and present the image to the operator.

Frequently, derotation is completed by successive image interpolation. Image interpolation works by using known data of a pixel or group of pixels to estimate values of unknown points—i.e., a desired pixel location. Image interpolation of a desired pixel considers the nearest neighboring pixel value or the closest neighborhood of known pixel values to interpolate a value for the desired pixel at a desired pixel location, and is successively executed to generate an interpolated image frame. Said image frame can be compiled with other interpolated image frames to create derotated video source.

Operators have frequented the need to derotate multiple video sources for their disposal. Operators also frequent the need to view multiple video source simultaneously. Derotating and displaying multiple video sources requires multiple video displays, increasing the need for physical space for the multiple video displays and also requires the operator to shift their view between the displays.

### SUMMARY OF THE TECHNOLOGY

In light of the needs described above, in at least one aspect, the subject technology relates to a method of electronically derotating a picture-in-picture image comprising processing a first image having a first image primary axis; processing a second image having a second image primary axis; derotating the second image around the second image primary axis to align the second image primary axis substantially parallel with the first image primary axis; and displaying the first image and the second image on a display.

In at least one aspect, the subject technology relates to derotating a second image around the second image primary axis comprising interpolating pixel values based on neighboring pixels.

In at least one aspect, the subject technology relates to interpolating pixel values based on neighboring pixels comprising four by four bicubic interpolation.

In at least one aspect, the subject technology relates to interpolating pixel values based on neighboring pixels comprising computing an average pixel value of other nearby pixels.

In at least one aspect, the subject technology relates to interpolating pixel values based on neighboring pixels comprising inputting a pixel rotation angle.

In at least one aspect, the subject technology relates to storing the pixel values in memory.

In at least one aspect, the subject technology relates to displaying the first image and second image on a display comprising overlaying the second image on top of the first image.

In at least one aspect, the subject technology relates to multiplexing the first image and second image.

In at least one aspect, the subject technology relates to derotating the first image around the first image primary axis.

In at least one aspect, the subject technology relates to processing a programmable image center for rotation.

In at least one aspect, the subject technology relates to a method of electronically derotating a picture-in-picture image comprising processing a picture-in-picture image, the picture-in-picture image comprising pixels; interpolating a pixel of the picture-in-picture image to derotate the interpolated pixel to form a derotated interpolated pixel; compiling derotated interpolated pixels to form a derotated picture-in-picture image; and presenting the derotated picture-in-picture image simultaneously with a primary image.

In at least one aspect, the subject technology relates to interpolating a pixel of the picture-in-picture image comprising computing an average pixel value of other nearby pixels.

In at least one aspect, the subject technology relates to interpolating a pixel of the picture-in-picture image comprising inputting the rotation angle of other nearby pixels, the rotation angle relative to a primary image axis.

In at least one aspect, the subject technology relates to interpolating a pixel of the picture-in-picture image comprising inputting the intensity of the other nearby pixels.

In at least one aspect, the subject technology relates to interpolating a pixel of the picture-in-picture image comprising inputting the position of the other nearby pixels.

In at least one aspect, the subject technology relates to computing an average pixel value of other nearby pixels comprising assigning a higher weight to the most proximate nearby pixels of a pixel to be interpolated.

In at least one aspect, the subject technology relates to computing an average pixel value of other nearby pixels comprising computing an average of sixteen nearby pixels.

In at least one aspect, the subject technology relates to compiling derotated picture-in-picture images to form a derotated output picture-in-picture video source.

In at least one aspect, the subject technology relates to a method of electronically resizing a picture-in-picture image comprising processing a first image having a first image primary axis; processing a second image having a second image primary axis; resizing the second image with respect to the second image primary axis to align the second image primary axis substantially parallel with the first image primary axis; displaying the first image and the second image on a display.

### BRIEF DESCRIPTION OF THE DRAWINGS

So that those having ordinary skill in the art to which the disclosed system pertains will more readily understand how to make and use the same, reference may be had to the following drawings.

FIG. 1 is a system block diagram showing a method of electronically derotating a picture-in-picture image through processing a first image and second image, derotating the second image, and displaying the first image and second image, according to an aspect of the subject technology.

FIG. 2 is a software-control flow diagram showing a method for derotating and enabling a picture-in-picture source video independent of a primary video source, according to an aspect of the subject technology.

FIG. 3 is a simplified system block diagram showing an illustrative embodiment of the hardware to implement electronic derotation, according to an aspect of the subject technology.

FIG. 4 is a system block diagram showing an illustrative embodiment of hardware to implement electronic derotation, according to an aspect of the subject technology.

### DETAILED DESCRIPTION

The subject technology overcomes many of the prior art problems associated with derotating multiple video sources. In brief summary, the subject technology provides for a method that electronically derotates imagery, to be displayed as a picture-in-picture within a primary image display. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be on top).

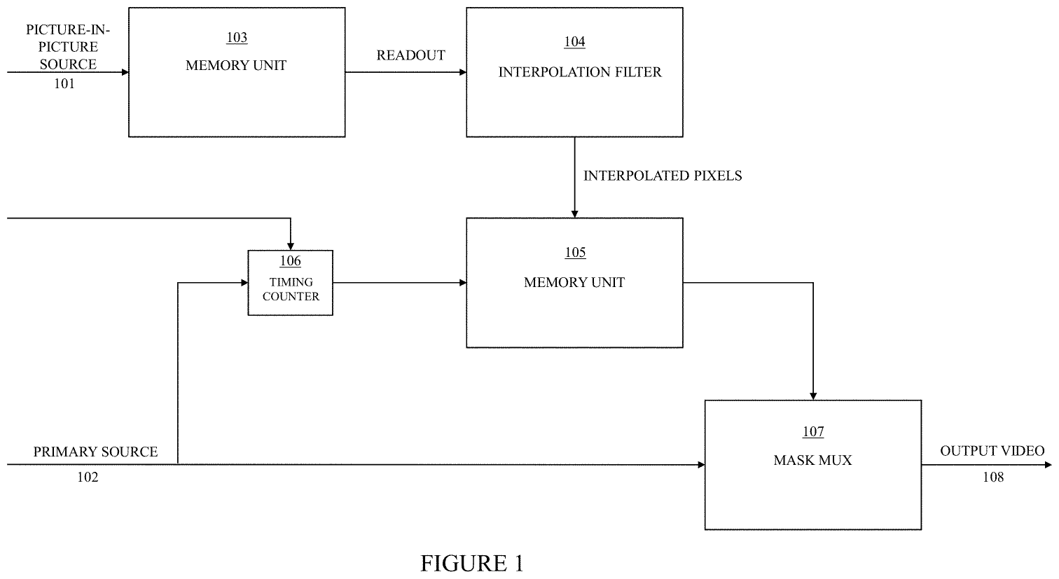

Referring now to FIG. 1, a picture-in-picture video source 101 and a primary video source 102 are shown. The picture-in-picture video source and the primary video source comprise images frames, the image frames each comprising a primary axis relative either to a programmable image center or optical image center.

An operator may select which video source is to be distinguished as the picture-in-picture source and which source is to be distinguished as the primary source. A picture-in-picture video source may be collected from a camera, sensor, or the like. The picture-in-picture video source, primary video source, or both may require accurate rotation relative to the operator due to the movement or rotation of the video source.

Initially, according to an aspect of the subject technology, the picture-in-picture video source may be written onto a memory unit 103. The memory unit 103 may be dynamic random-access memory, static access memory, serial access memory, direct access memory, cache memory, auxiliary memory, serial ATA storage, solid-state storage, a computer system interface, a parallel advanced technology attachment drive, electro-mechanical data storage device, or the like. The memory unit may comprise any organization, for example 2M×36-bit or the like, or comprise any operating mode, for example QDR II or the like. The picture-in-picture video source may be written into or read out of the memory unit using existing frequency, i.e., faster or slower than the primary video source frequency. In one embodiment of the subject technology, the picture-in-picture video source may write onto the memory unit at a 120 Hertz rate or read out of the memory unit a 120 Hertz rate, equal to or different from its existing frequency, independent of the primary video source frequency. The picture-in-picture video source may also be read out of the memory unit 103 at a frequency equal to the primary video source rate so as to allow an operator to downsample or upsample the picture-in-picture video source to match the primary video source frequency.

For each pixel in each frame of the picture-in-video source, a corresponding neighboring pixel or several neighboring pixels are read out of memory unit 103 in bursts. In one embodiment of the subject technology, the picture-in-picture video source may be a '720p source comprising 1280 by 720 pixels per frame. Thus, for each of the 921,600 pixels in each picture-in-picture video source frame, a burst of a corresponding neighboring pixel or several neighboring pixels may read out. In a preferred embodiment, for each pixel in each picture-in-picture video source frame, 16 neighboring pixels are read out of memory unit 103. In other embodiments, 1 neighboring pixel, 4 neighboring pixels, 9 neighboring pixels, or a higher order of neighboring pixels may be read from memory unit 103 corresponding to each pixel in each frame of the picture-in-picture video source. The neighboring pixels are used to interpolate the initial pixel value at a new location, rotation, color or intensity or any combination of location, rotation, color and intensity.

The neighboring pixels are read out into an interpolation filter 104. Therein, for each pixel in each frame of the picture-in-picture video source, neighboring pixels, 16 for example, are interpolated to provide a new pixel value of the initial pixel at a different location, rotation, color or intensity or any combination of location, rotation, color and intensity. For each frame of the picture-in-picture video source, a programmable image center, or primary axis, may be retrieved. The primary axis may be the optical image center however. For each frame and corresponding primary axis, a rotation relative to the primary axis may be measured by a resolver, gyroscope, or other measurement device. Interpolation may comprise computing an average pixel rotation value relative the primary axis to predict a pixel rotation value for the initial pixel at a different rotation. Interpolation may also comprise computing an average pixel value of a neighboring pixel or pixels corresponding to, at least in part, the color, intensity, or position of the picture-in-picture source frame. In computing an average pixel value, the closest neighboring pixels to the initial pixel may be assigned a higher weight.

This process may be repeated across each frame of the picture-in-picture video source. Using the new pixel values of each frame of the picture-in-picture source, a new, derotated or resized image is processed and can be stored in memory unit 105. The memory unit 105 may be dynamic random-access memory, static access memory, serial access memory, direct access memory, cache memory, auxiliary memory, serial ATA storage, solid-state storage, a computer system interface, a parallel advanced technology attachment drive, electro-mechanical data storage device, or the like. The memory unit may comprise any organization, for example 32M×64-bit or the like, or comprise any operating mode, for example QDR II or the like. The derotated picture-in-picture video source may be written into or read out of the memory unit 105 at a rate equal to the primary video source rate so as to allow an operator to downsample or upsample the derotated picture-in-picture video source to match the primary video source rate.

Simultaneous to derotating the picture-in-picture video source, the primary video source may or may not be derotated. The primary video source may not require derotating if the primary video source is derived from a stationary optical source collection unit as opposed to a moving optical source collection unit. Alternatively, the primary video source may require derotating if the primary video source is derived from a moving optical source collection unit as opposed to a stationary moving optical source collection unit. Examples of a moving optical source collection units may include, but are not limited to, cameras or sensors mounted to an airplane or rocking boat.

Based on the timing counter 106 associated with the primary video source readout, i.e. 120 Hertz, and the desired location of the derotated picture-in-picture video source relative to the primary video source, i.e. in the upper-most right-hand corner of the primary video source, the derotated picture-in-picture video source is then read out of memory unit 105 and multiplexed with the primary video source accordingly. The derotated picture-in-picture video source may be multiplexed with the primary video source by space-division multiplexing, frequency-division multiplexing, time-division multiplexing, polarization-division multiplexing, orbital angular momentum multiplexing, code-division multiplexing, or the like.

The multiplexed video source may then be transmitted 108 to a display.

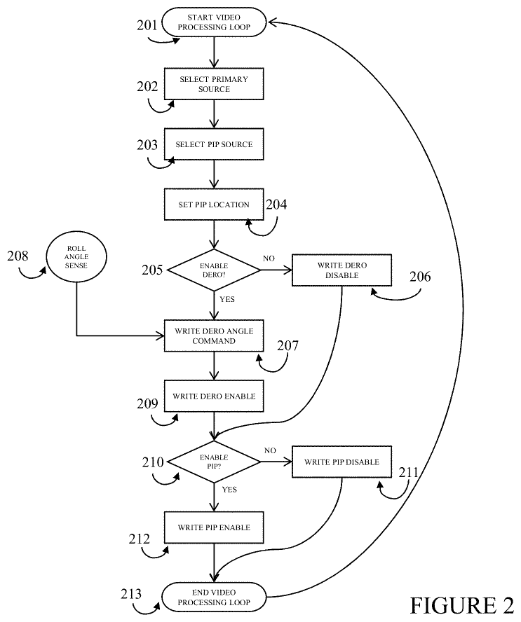

Referring now to FIG. 2, a software-control flow diagram showing a method for derotating and enabling a picture-in-picture source video independent of a primary video source. A video processing loop 201 initiates when a video muxer or the like is employed to select the source of video of the primary source 202. Another video muxer or the like is employed to select the source of video into the picture-in-picture source 203. A control is employed to set the location of the picture-in-picture source relative to the primary source when displayed 204. A control is employed to enable the derotation process 205 or disable the derotation process. If the derotation process is enabled 209, the rotation angle, or roll angle is sensed by a measurement device in such a system 208, whether the measurement device is a resolver, gyroscope, or other measurement device, the measurement device transmitting a pixel angle measurement into the derotation angle command 207. Alternatively, if the derotation process is disabled 206, the roll angle is not sensed, and rather a 0 degree pixel angle measurement is fed into the derotation angle command. A control is employed 210 to enable the picture-in-picture video source 212 or disable the picture-in-picture video source 211. The video processing loop ends thereafter 213.

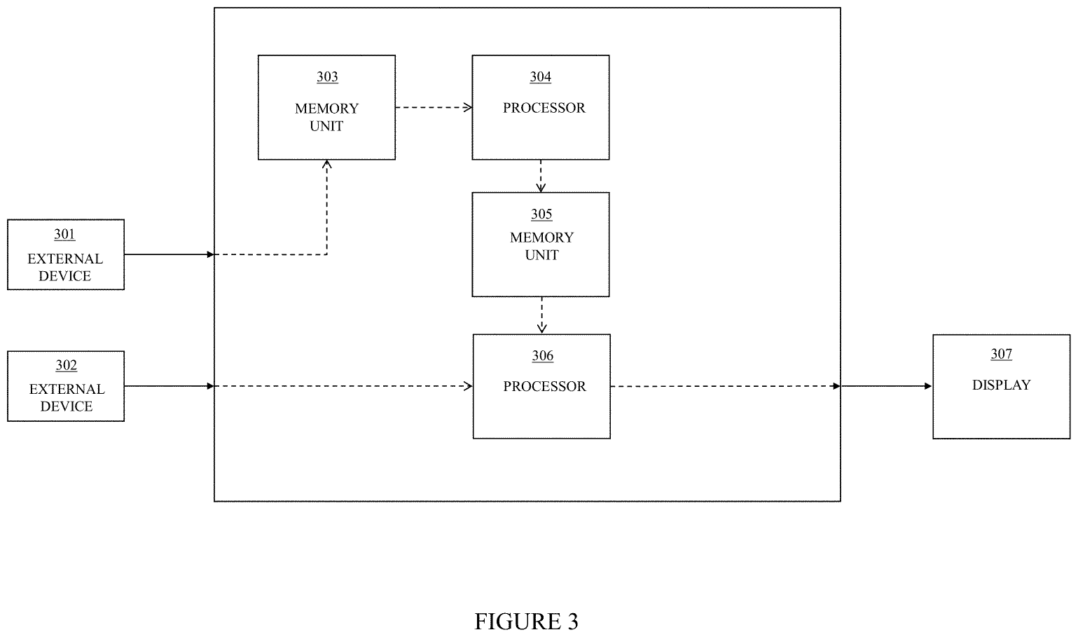

Referring now to FIG. 3, a system block diagram showing an illustrative embodiment of the hardware behind the picture-in-picture electronic derotation methods is shown. Although the subject technology is not limited to a single hardware implementation, an illustrative embodiment of the subject technology is described herein. In the illustrative embodiment, an external device 301, such as a camera, sensor, or the like collects and transmits a picture-in-picture video source. A mid-wave infrared sensor or a visible and near infrared sensor are examples external device sensors. An external device 302, such as a camera, sensor, or the like collects and transmits a primary video source similarly. An operator may select which source is to be distinguished as the picture-in-picture source and which source is to be distinguished as the primary source. In an illustrative embodiment, the data collected by the external device selected as the picture-in-picture video source is transmitted to a memory unit 303. The memory unit 303 reads out the picture-in-picture video source to a processing unit 304. The picture-in-picture video is derotated therein and read out to a second memory unit 305. The derotated picture-in-picture video is then read out to a second processing unit 306 and multiplexed with the primary video source collected. The memory units 303 and 305 and processor units 304 and 306 are implemented on a single field-programmable gate array. The multiplexed derotated picture-in-picture video and primary video source are then displayed onto a display 307.

It should be appreciated by those of ordinary skill in the pertinent art that the hardware embodiment of the subject technology may comprise a single or several external input devices, a single or several memory units, a single or several processors, a single or several displays, or a single or several field-programmable gate arrays.

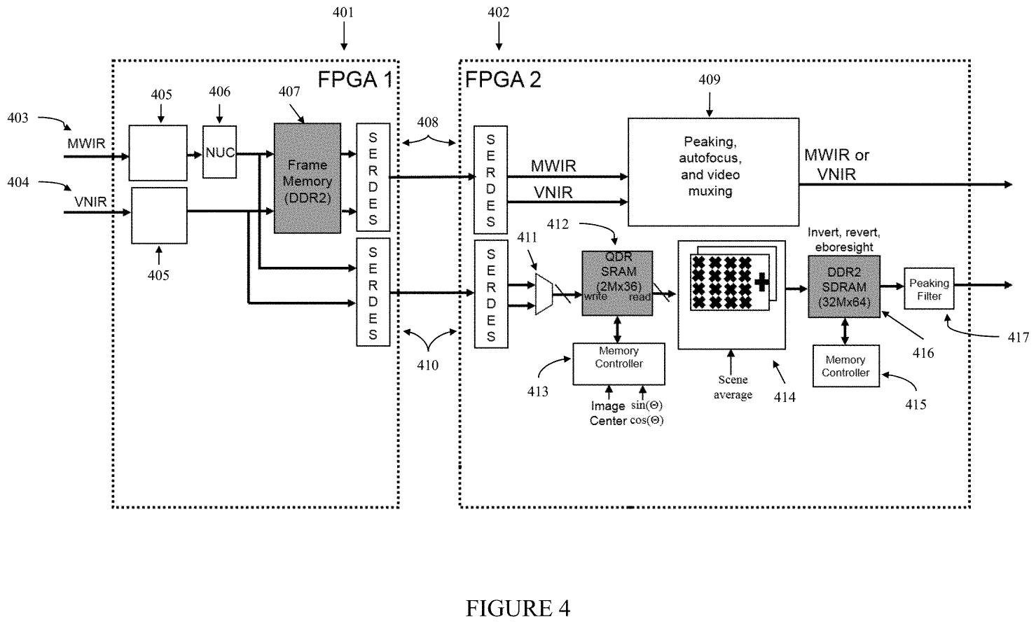

Referring now to FIG. 4, a system block diagram showing an illustrative embodiment of hardware to implement electronic derotation is shown. Although the subject technology is not limited to a single hardware implementation, an illustrative embodiment of the subject technology is described herein. In the illustrative embodiment, two field-programmable gate arrays, 401 and 402, are shown, which may be designed or configured with a varying array of programmable logic blocks and a varying array of reconfigurable interconnects. It should be appreciated that one or several field-programmable gate arrays may suffice to implement the subject technology. An external device such as a mid-wave infrared (MWIR) sensor 403 or a visible and near infrared (VNIR) sensor 404 is multiplexed upstream for derotation. In the illustrative embodiment, either of the sensor sources or another external device source may be selected and multiplexed for derotation. It is an object of the subject technology that the selected sensor source multiplexed for derotation is to be displayed as a picture-in-picture image. Though the primary image, which the picture-in-picture image is to overlay, may also require derotation, and as such, may follow a similar derotation method.

The selected source is transmitted to a communications link 405. The communications link 405 may standardize the connection between the external device input and a subsequent frame grabber. A non-uniformity correction unit (NUC) 406 may be employed depending on the type of corresponding external device source. Generally, a non-uniformity correction unit is not required for visible light sensor sources since visible light sensor detector responses are relatively uniform. Though, a non-uniformity correction unit may be employed when a corresponding external device transmits radio, microwave, infrared, ultraviolet, x-ray, or gamma ray signal to the field-programmable gate array. Thus, a mid-wave infrared sensor may require a non-uniformity correction unit within the field-programmable field array. The non-uniformity correction unit may be employed on any source path, and as such may be employed prior to transmission to the Serializer/Deserializer (SERDES) pair of functional blocks 410.

The selected source, may thereafter be transmitted to the SERDES pair of functional blocks 410 to compensate for potential limited input/output. The SERDES function architecture may comprise parallel clock SERDES, embedded clock SERDES, 8b/10b SERDES, bit interleaved SERDES, or the like. The selected source is multiplexed 411 and each frame of the source may be written into the memory unit 412. The memory unit 412 may be dynamic random-access memory, static access memory, serial access memory, direct access memory, cache memory, auxiliary memory, serial ATA storage, solid-state storage, a computer system interface, a parallel advanced technology attachment drive, electro-mechanical data storage device, or the like. In the illustrative embodiment, the memory unit 412 is QDR SRAM to provide high pixel throughput. The memory unit may comprise any organization, for example 2M×36-bit or the like, or comprise any operating mode, for example QDR II or the like.

For each frame of the selected source, the memory controller 413 may receive the programmable image center for rotation, or image primary axis, thus providing a flexible architecture when selected source images are not optically centered. Though, the memory controller may receive the optical image center for rotation, or image primary axis, alternatively. In addition, the memory controller 413 may receive the rotation angle for each frame or each pixel of each frame of the selected source relative to the primary axis of the image. The rotation angle, or roll angle may sensed by a measurement device, whether the measurement device is a resolver, gyroscope, or other measurement device, the measurement device capable of transmitting the rotation angle for each frame of the selected source to the memory controller 412. The measurement device may be located internally or externally relative to the single or various field-programmable gate arrays.

The interpolation filter 414 may interpolate the selected source image using the rotation angle of the selected source frame or each pixel of each frame relative to the primary axis. Thus, for each pixel in each frame of the selected source, neighboring pixels, 16 for example, are interpolated to provide a new pixel value of the initial pixel at a different rotation to provide for a derotated output pixel position. Interpolation is repeated until a derotated output pixel position is calculated for every pixel in the output frame. An algorithm of the user's choice, such as a trigonometric function, may be implemented to calculate the derotated output pixel position for every pixel in the output frame.

Interpolation may also comprise computing a new pixel value of an initial pixel corresponding to, at least in part, the color, intensity, or position of the selected source frame or each pixel of each frame, to provide a new pixel value of the initial pixel with a different color, intensity, or position. In interpolating each pixel in each frame of the selected source, the closest neighboring pixels to the initial pixel may be assigned a higher weight.

The output pixel is then written into a memory unit 416 at its computed rotation. The memory unit 416 may be dynamic random-access memory, static access memory, serial access memory, direct access memory, cache memory, auxiliary memory, serial ATA storage, solid-state storage, a computer system interface, a parallel advanced technology attachment drive, electro-mechanical data storage device, or the like. In the illustrative embodiment, the memory unit 416 is DDR2 SDRAM. The memory unit may comprise any organization, for example 32M×64-bit or the like, or comprise any operating mode, for example QDR II or the like.

The output pixel may be written into the memory unit 416 corresponding to its computed color, intensity, or position also. A filler pixel may be written into the memory unit 416 when the output frame exceeds the input image pixel size, the filler pixel comprising an intensity, color, or position. The filler pixel may comprise an average intensity, color, or position corresponding to neighboring output pixels.

The output frame may be manipulated electronically through inversion, reversion, eboresight, or the like using the memory controller 415. The memory controller 415 may then be employed to read out a series of interpolated frames to create a derotated video source which may be altered by a peaking filter 417, the peaking filter comprising the functionality to peak, autofocus, or video mux the derotated video source. The derotated video source thereafter may be multiplexed and displayed with another video source to create picture-in-picture imagery, as described in FIG. 1.

In some situations a sensor video source 403, whether the sensor video source is a mid-wave infrared sensor, a visible and near infrared sensor, or another external device, may not require derotation. In the illustrative embodiment, this video source may similarly be transmitted to a communications link 405 and subsequently a non-uniformity correction unit 406, depending on the external device. This video source may similarly be transmitted to a SERDES pair of functional blocks 408, and may similarly be transmitted to a peaking filter 409. This video source thereafter may be multiplexed and displayed with another video source to create picture-in-picture imagery, as described in FIG. 1.

All orientations and illustrative embodiments of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g. memory, processors, displays and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A method of electronically derotating a picture-in-picture image comprising:
processing a first image having a first image primary axis;
processing a second image having a second image primary axis;
derotating the second image around the second image primary axis to align the second image primary axis substantially parallel with the first image primary axis; and
displaying the first image and the second image on a display.

2. The method of electronically derotating a picture-in-picture image in claim 1 wherein derotating the second image around the second image primary axis comprises interpolating pixel values based on neighboring pixels.

3. The method of electronically derotating a picture-in-picture image in claim 2 wherein interpolating pixel values based on neighboring pixels comprises four by four bicubic interpolation.

4. The method of electronically derotating a picture-in-picture image in claim 2 wherein interpolating pixel values based on neighboring pixels comprises computing an average pixel value of other nearby pixels.

5. The method of electronically derotating a picture-in-picture image in claim 2 wherein interpolating pixel values based on neighboring pixels comprises inputting a pixel rotation angle.

6. The method of electronically derotating a picture-in-picture image in claim 2 further comprising storing the pixel values in memory.

7. The method of electronically derotating a picture-in-picture image in claim 1 wherein displaying the first image and second image on a display comprises overlaying the second image on top of the first image.

8. The method of electronically derotating a picture-in-picture image in claim 1 further comprising multiplexing the first image and second image.

9. The method of electronically derotating a picture-in-picture image in claim 1 further comprising derotating the first image around the first image primary axis.

10. The method of electronically derotating a picture-in-picture image in claim 1 further comprising processing a programmable image center for rotation.

11. A method of electronically derotating a picture-in-picture image comprising:
processing a picture-in-picture image, the picture-in-picture image comprising pixels;
interpolating a pixel of the picture-in-picture image to derotate the interpolated pixel to form a derotated interpolated pixel;
compiling derotated interpolated pixels to form a derotated picture-in-picture image; and
presenting the derotated picture-in-picture image simultaneously with a primary image.

12. The method of electronically derotating a picture-in-picture image in claim 11 wherein interpolating a pixel of the picture-in-picture image comprises computing an average pixel value of other nearby pixels.

13. The method of electronically derotating a picture-in-picture image in claim 11 wherein interpolating a pixel of the picture-in-picture image comprises inputting the rotation angle of other nearby pixels, the rotation angle relative to a primary image axis.

14. The method of electronically derotating a picture-in-picture image in claim 11 wherein interpolating a pixel of the picture-in-picture image comprises inputting the intensity of the other nearby pixels.

15. The method of electronically derotating a picture-in-picture image in claim 11 wherein interpolating a pixel of the picture-in-picture image comprises inputting the position of the other nearby pixels.

16. The method of electronically derotating a picture-in-picture image in claim 12 wherein computing an average pixel value of other nearby pixels comprises assigning a higher weight to the most proximate nearby pixels of a pixel to be interpolated.

17. The method of electronically derotating a picture-in-picture image in claim 12 wherein computing an average pixel value of other nearby pixels comprises computing an average of sixteen nearby pixels.

18. The method of electronically derotating a picture-in-picture image in claim 11 further comprising compiling derotated picture-in-picture images to form a derotated output picture-in-picture video source.

19. A method of electronically resizing a picture-in-picture image comprising:
processing a first image having a first image primary axis;
processing a second image having a second image primary axis;
resizing the second image with respect to the second image primary axis to align the second image primary axis substantially parallel with the first image primary axis;
displaying the first image and the second image on a display.
